(19) United States
(12) Patent Application Publication
(10) Pub. No.: US 2006/0189337 A1
(43) Pub. Date: Aug. 24, 2006

(54) Premium voice services for wireless communications systems

(76) Inventors: Craig F. Farrill, Danville, CA (US); Bruce D Lawler, San Jose, CA (US); Krishnakant M Patel, Richardson, TX (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 10/564,903

(22) PCT Filed: Jul. 16, 2004
(86) PCT No.: PCT/US04/23038

§ 371 Date: Jan. 17, 2006

Related U.S. Application Data
(60) Provisional application No. 60/488,638, filed on Jul. 18, 2003.
(60) Provisional application No. 60/492,650, filed on Aug. 5, 2003.
(60) Provisional application No. 60/576,094, filed on Jun. 2, 2004.

(51) Int. Cl. H04B 7/00; H04Q 7/20

(52) U.S. Cl. 455/518

(57) ABSTRACT

Two advanced group-based voice services, known as Push-to-Conference (P2C) and Push-to-Message (P2M) services are provided by a real-time exchange (RTX) that interfaces to the wireless network. The RTX provides a full-duplex Push-to-Conference (P2C) session between an initiator and two or more other participants, wherein the P2C session comprises a full-duplex conference call, and both the real time exchange and handsets participating in the P2C session communicate with each other using call setup and in-band signaling within the wireless network. The realtime exchange may be coupled to and work with a Push-to-Message (P2M) server to deliver multimedia messages in a non-real time manner from an originator to one or more recipients, without establishing voice paths between the originator and recipients, wherein the P2M server, and an optional Voice Mail Server, provide a message storage facility for the multimedia messages. Additionally, a technique based on handset speech buffering permits zero delay call set-ups to be achieved.

### CROSS REFERENCE TO RELATED APPLICATIONS

This application claims the benefit under 35 U.S.C. Section 119(e) of the following co-pending and commonly-assigned U.S. provisional patent applications:

Ser. No. 60/488,638, filed on Jul. 18, 2003, by F. Craig Farrill, Bruce D. Lawler and Krishnakant Patel, entitled REAL-TIME EXCHANGE, attorneys' docket number 154.7-US-P1;

Ser. No. 60/492,650, filed Aug. 5, 2003, by Bruce D. Lawler, Krishnakant Patel, and F. Craig Farrill, entitled CDMA PRESS-TO-TALK (P2T) PROOF-OF-CONCEPT DEMONSTRATION, attorneys' docket number 154.8-US-P1; and

Ser. No. 60/576,094, filed Jun. 2, 2004, by Craig Farrill, Bruce Lawler, and Krishnakant Patel, entitled TECHNIQUE FOR ZERO DELAY CALL SET-UP IN P2T SYSTEMS, attorneys' docket number 154.14-US-P1;

all of which applications are incorporated by reference herein.

This application is a continuation-in-part and claims the benefit under 35 U.S.C. Section 120 of the following co-pending and commonly-assigned PCT utility patent application:

Serial Number PCT/US03/16386, filed on May 23, 2003, by Gorachand Kundu, Ravi Ayyasamy, and Krishnakant Patel, entitled DISPATCH SERVICE ARCHITECTURE FRAMEWORK, attorneys' docket number 154.4-WO-U1, which application claims the benefit under 35 U.S.C. Section 119(e) of the following co-pending and commonly-assigned U.S. provisional patent applications:

Ser. No. 60/382,981, filed on May 24, 2002, by Gorachand Kundu, Ravi Ayyasamy, and Krishnakant Patel, entitled RADIO GATEWAY ARCHITECTURE FRAMEWORK, attorneys' docket number 154.3-US-P1;

Ser. No. 60/383,179, filed May 24, 2002, by Gorachand Kundu, Ravi Ayyasamy, and Krishnakant Patel, entitled DISPATCH SERVICE ARCHITECTURE FRAMEWORK, attorneys' docket number 154.4-US-P1; and

Ser. No. 60/407,168, filed Aug. 30, 2002, by Gorachand Kundu, Ravi Ayyasamy, and Krishnakant Patel, entitled DISPATCH SERVICE ARCHITECTURE FRAMEWORK, attorneys' docket number 154.5-US-P1;

all of which applications are incorporated by reference herein.

### BACKGROUND OF THE INVENTION

1. Field of the Invention

This invention relates in general to wireless communications systems, and more specifically, to a dispatch service providing premium voice services for wireless communications systems.

2. Description of Related Art

Group-based voice services, such as two-way half-duplex voice calls within a group, also known as “Push-to-Talk,” “Press-to-Talk,” PTT or P2T, have enormous revenue earnings potential for wireless networks, such as cellular networks and personal communications systems (PCS) networks. Corporate subscribers primarily use such services for coordinating field people or fleet users from a central location.

Currently, there are three major approaches employed in providing group-based voice services such as P2T in wireless networks. One approach requires the installation of a dedicated private network, parallel to the wireless network, to support the group-based voice services. NEXTEL uses such a system, based on a solution developed by MOTOROLA known as IDEN. However, a dedicated private network is costly to install and maintain and is employed by a few public wireless carriers. Also, the IDEN system is non-standard, and hence cannot be used in standard wireless communications networks, such as those based on CDMA and GSM.

Another approach is based on Voice over IP (VoIP) technologies. While this approach promises compliance with newer and emerging standards, such as GPRS (General Packet Radio Service), UMTS (Universal Mobile Telecommunications System), etc., it does not provide a solution for carriers employing wireless networks based on existing standards, such as GSM (Global System for Mobile Communications), CDMA (Code Division Multiple Access), etc. However, even for the newer standards, solutions based on VoIP have serious drawbacks, including slower call setup, significant overhead, increased susceptibility to packet losses, low bit rate voice coders, and significant modifications to the mobile handset. There is a need, instead, for solutions that require only minimal upgrades to the handset.

Still another approach is that defined in co-pending and commonly-assigned PCT utility patent application Serial Number PCT/US03/16386, filed on May 23, 2003, by Gorachand Kundu, Ravi Ayyasamy, and Krishnakant Patel, entitled DISPATCH SERVICE ARCHITECTURE FRAMEWORK, attorneys' docket number 154.4-WO-U1, which application is incorporated by reference herein. In this approach, group-based voice services are provided by a dispatch gateway that interfaces to the wireless network to provide the group-based voice services therein, wherein both the dispatch gateway and mobiles that use the group-based voice services communicate with each other using call setup and in-band signaling within the wireless network.

Notwithstanding these innovations, there is a need in the art for advanced group-based voice services that comply with existing and emerging wireless standards and provide superior user experiences. The present invention aims to satisfy this need by providing an architectural framework for performing these advanced group-based voice services within wireless networks.

### SUMMARY OF THE INVENTION

To overcome the limitations in the prior art described above, and to overcome other limitations that will become apparent upon reading and understanding the present specification, the present invention discloses two advanced group-based voice services, known as Push-to-Conference (P2C) and Push-to-Message (P2M) services. The present invention also identifies a technique to achieve zero call-delay during call origination in Press-to-Talk services to enhance the user's experience.

A real-time exchange (RTX) interfaces to the wireless network to provide a full-duplex Push-to-Conference (P2C) session between an initiator and two or more other participants, wherein the P2C session comprises a full-duplex conference call, and both the real-time exchange and handsets participating in the P2C session communicate with each other using call setup and in-band signaling within the wireless network.

The real-time exchange may be coupled to and work with a Push-to-Message (P2M) server to deliver multimedia messages in a non-real time manner from an originator to one or more recipients, without establishing voice paths, between the originator and recipients, wherein the P2M server, and an optional Voice Mail Server, provide a message storage facility for the multimedia messages.

The handsets also permit zero-delay call setup. The user starts talking immediately upon initiation of call setup, wherein the user's speech is buffered by the handset. The buffered speech is then forwarded to the destination upon completion of the call setup.

### BRIEF DESCRIPTION OF THE DRAWINGS

Referring now to the drawings in which like reference numbers represent corresponding parts throughout:

FIG. 1 is a block diagram that illustrates an exemplary embodiment of the dispatch services architecture framework according to a preferred embodiment of the present invention;

FIG. 2 illustrates a proposed architecture for the real-time exchange according to the preferred embodiment of the present invention;

FIG. 3 is a diagram that illustrates the call flow for the user initiating a P2C session according to the preferred embodiment of the present invention;

FIG. 4 is a diagram that illustrates the call flow for the user upgrading a P2T session to a P2C session according to the preferred embodiment of the present invention;

FIG. 5 is a diagram that illustrates the call flow for the user receiving an upgrade of a P2T session to a P2C session according to the preferred embodiment of the present invention;

FIG. 6 illustrates a system architecture for the P2M service according to the preferred embodiment of the present invention;

FIG. 7 is a diagram that illustrates the call flow between a P2M server and a voice mail server according to the preferred embodiment of the present invention;

FIG. 8 is a diagram that illustrates the call flow for the P2M Client sending a voice message using a Multi Media Services (MMS) protocol according to the preferred embodiment of the present invention;

FIG. 9 is a diagram that illustrates the call flow for the P2M server processing a P2M message according to the preferred embodiment of the present invention;

FIG. 10 is a diagram that illustrates the call flow for the P2M Server retrieving a P2M message according to the preferred embodiment of the present invention;

FIG. 11 is a diagram that illustrates the call flow for the P2M Client deleting a P2M message according to the preferred embodiment of the present invention;

FIG. 12 depicts the processing at the handset to implement zero delay call set-up according to the preferred embodiment of the present invention;

FIG. 13 is a diagram that illustrates the call flow for a GSM P2T call according to a preferred embodiment of the present invention; and

FIG. 14 is a diagram that illustrates the call flow for a CDMA P2T call according to a preferred embodiment of the present invention.

### DETAILED DESCRIPTION OF THE INVENTION

In the following description of the preferred embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

Overview

The present invention provides two advanced group-based voice services, known as Push-to-Conference (P2C) and Push-to-Message (P2M) services, in addition to Press-to-Talk (P2T) services. These services are provided by an architectural framework that interfaces into the wireless network in order to provide group call setup and messaging. The present invention describes the architectural framework in more detail below, and also shows the call flows for performing these advanced group-based voice services within the wireless network.

Network Architecture

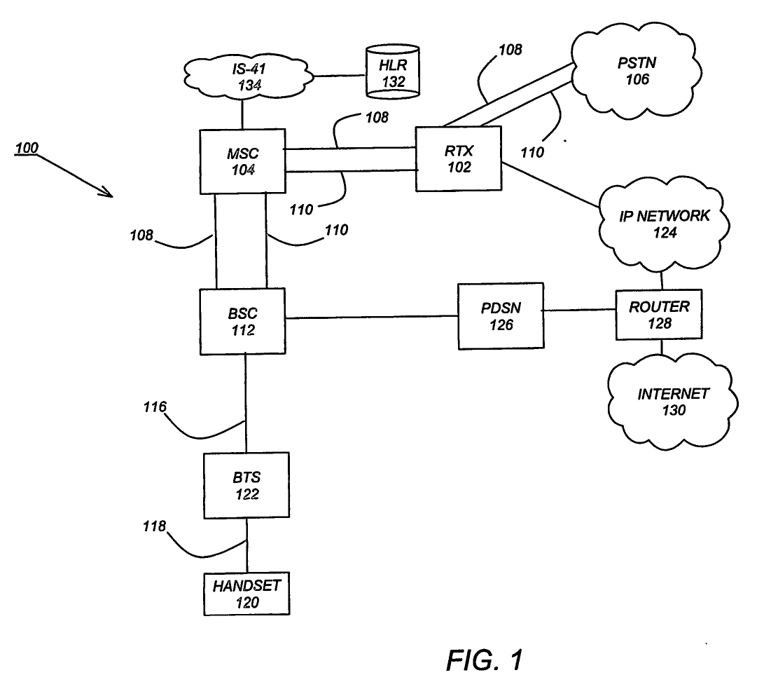

FIG. 1 is a block diagram that illustrates an exemplary embodiment of a wireless communications network according to a preferred embodiment of the present invention.

Within the network 100, an RTX (Real-Time Exchange) 102, previously known as a Dispatch Gateway (DG), communicates with a MSC (Mobile Switching Center) 104 and PSTN (Public Switched Telephone Network) 106 using SS7—ISUP/WIN/CAMEL (Signaling System 7—Integrated Services Digital Network User Part/Wireless Intelligent Network/Customized Applications for Mobile Enhanced Logic) messages at a signaling plane 108. A bearer path 110 implements a TDM (Time Division Multiplexing) interface carrying PCM (Pulse Code Modulation) or TFO (Tandem Free Operation) voice frames. Support for TFO in this path 110 is negotiated between a BSC (Base Station Controller) 112 and the RTX 102 for each originating and terminating leg of a group call. The use of TFO ensures high voice quality (as voice codec conversion is avoided) between mobile-to-mobile calls.

When a subscriber originates a group call, the MSC 104 routes the call to the RTX 102. The MSC 104 also requests the BSC 112 via 116 to establish a radio traffic path 118 with the mobile handset 120 via the BTS (Base Transceiver Station) 122 (as it does for a normal cellular call). At this time, the BSC 112 tries to negotiate TFO (if it is supported) on a TDM link with the far end (in this case, the RTX 102).

At the same time (after the MSC 104 terminates the group call request to the RTX 102), the RTX 102 identifies the terminating group users and their MS-ISDN (Mobile Station ISDN Number) numbers. It sends a ISUP call origination request for each terminating handset 120. It may send requests directly to the MSC 104, PSTN 106 or 1P network 124 via a PDSN (Public Data Switched Network) 126, Router 128, and/or Internet/Intranet 130, depending on the routing table configuration for terminating MS-ISDN numbers. Once the bearer path 110 is established, the RTX 102 begins a negotiation with the far end (in this case, the terminating BSC 112) for each terminating leg to a handset 120.

Once bearer paths 110 are established for originating and terminating legs for a group call, the RTX 102 switches (or duplicates) voice frames from the originating handset 120 to all terminating mobiles 120.

The RTX 102 may use an IP network 124 or the Intemet/Intranet 130 for two different purposes. The IP network 124 or the Intemet/Intranet 130 can be used in a toll bypass mode where two RTXs 102 can exchange voice traffic bypassing the PSTN 106. However, each RTX 102 is responsible for terminating traffic to its closest MSC 104. In this case, the IP network 124 or the Internet/Intranet 130 is used as a backbone transport of voice traffic between two RTXs 102.

The IP network 124 or the Intemet/Intranet 130 can also be used for a registration and presence application. Since the MSC 104 will not direct a registration request from a handset 120 to the RTX 102 (because it would require changes in the MSC 104), the latter does not have any information of the registered mobiles 120. To circumvent this issue, a registration and presence application runs over an IP stack in the handset 120. After the handset 120 registers for a data interface (i.e., obtaining an IP address) with the PDSN 126, the registration and presence application in the handset 120 registers with the RTX 102 using its IP address. The RTX 102 also uses this IP interface to update the presence information of other group members to a handset 120. There is also provision to use SMS (Short Message Service) transport to carry presence messages if an operator chooses to use SMS over a data channel.

During roaming, a Home Location Register (HLR) 132 can be accessed via the MSC 104 and an IS-41 link 134. The HLR 132 can be used to track the presence of members of a group within the network and updates the mobiles 120 for those members with the network availability of other members of the group. This is described in more detail later in this document.

Real Time Exchange

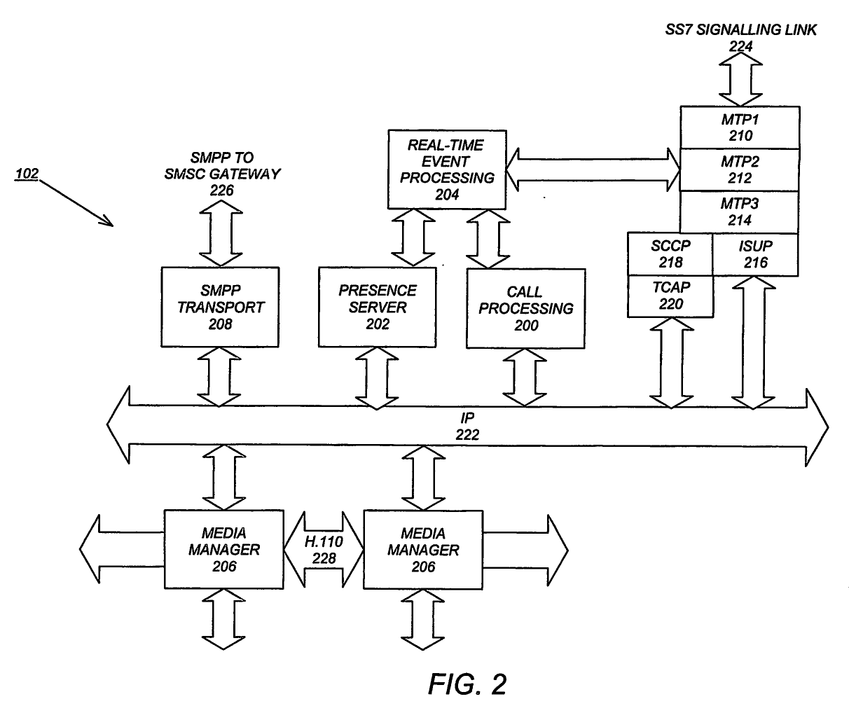

FIG. 2 illustrates a proposed architecture for the RTX 102 according to the preferred embodiment of the present invention.

The architecture includes a Call Processing system 200, Presence Server 202, Real-Time Event Processing system 204, one or more Media Managers 206, and an SMPP (Short Message Peer-to-Peer) Transport 208, as well as modules for various SS7 protocols, such as MTP-1 (Message Transfer Part Level 1) 210, MTP-2 (Message Transfer Part Level 2) 212, MTP-3 (Message Transfer Part Level 3) 214, ISUP (Integrated Services Digital Network User Part) 216, SCCP (Signaling Connection Control Part) 218, and TCAP (Transactions Capabilities Application Part) 220 protocols.

The Call Processing system 200, Presence Server 202, Media Managers 204, SMPP Transport 206, and other modules communicate across an IP network 222. The Real-Time Event Processing system 204 communicates directly with the Call Processing system 200, Presence Server 202, and the modules for various SS7 protocols. The modules for various SS7 protocols communicate with other entities via a SS7 Signaling Link 224. The SMPP Transport 206 communicates with a SMSC (Short Message Service Center) gateway using the SMPP protocol 226. The Media Managers 204 communicate among themselves using the H.110 protocol 228.

The operation of these various components are described in more detail below.

Push-to-Conference (P2C)

The RTX 102 interfaces to the wireless network 100 to provide support for a fall-duplex Push-to-Conference (P2C) session between an initiator and two or more other participants, wherein the P2C session comprises a full-duplex conference call, and both the RTX 102 and handsets 120 participating in the P2C session communicate with each other using call setup and in-band signaling within the wireless network 100. In this context, the participants may comprise one or more contacts, one or more groups of contacts, or a subset of a group of contacts.

The initiator may initiate the full-duplex P2C session by invoking “Push-to-Conference” on their handset 120. Alternatively, the initiator may upgrade an established half-duplex Push-to-Talk (P2T) session to the full-duplex P2C session by invoking “Upgrade to Conference” on their handset 120.

In either instance, the initiator's handset 120 signals the RTX 102 via the wireless network 100, e.g., by transmitting one or more configured DTMF (Dual Tone Multi Frequency) digits to the RTX 102. The Media Manager systems 206 receive the DTMF digits and pass the DTMF digits to the Call Processing system 200. The Call Processing (CP) system 200 determines whether the initiator has subscribed to the P2C feature before initiating the full-duplex P2C session. Upon confirmation, the Call Processing system 200 initiates a new P2C session and, when upgrading a P2T session, suspends floor management for the P2T session. The Call Processing system 200 interacts with the Presence Server 202 and Real-Time event Processing system 204 to cause the wireless network 100 to perform call setup with the other participants for the full-duplex P2C session, and thereafter to manage the full-duplex P2C session.

For example, the initiator hears the “Conference Confirmation” or “Conference Upgrade” tone, if the initiator's request is accepted by the RTX 102 to initiate the full-duplex P2C session. On the other hand, the RTX 102 can reject the request, if the initiator has not subscribed with the network operator for the P2C service, wherein the RTX 102 transmits an error tone (e.g., “bong”) to the initiator's handset 120.

In another example, the other participants hear a “Join Conference” tone, if the initiator's request to initiate the full-duplex P2C session is accepted by the RTX 102, or the other participants hear a “Conference Upgrade” tone, if the initiator's request to upgrade the half-duplex P2T session to the full-duplex P2C session is accepted by the RTX 102. The other participants then invoke “Join Conference” on their handsets 120 to join the full-duplex P2C session. Thereafter, the RTX 102 may respond with “Conference Confirmation” or “Conference Upgraded” tone as required.

During the full-duplex P2C session, the Call Processing system 200 interacts with the Media Manager systems 206 to maintain the H.110 channels 227 and assign any additional H.110 channels 228 required for the P2C session, which may span across multiple Media Manager systems 206. During the full-duplex P2C session, the Media Manager systems 206 of the RTX 102 are used to mix audio streams from the initiator and other participants, and then deliver these mixed audio streams to the initiator and other participants, for full-duplex conference calling. The H.110 channels 228 are used for passing mixed and unmixed audio streams voice between the Media Manager systems 200 as required.

Finally, the P2C session may be terminated in different ways. For example, the full-duplex P2C session may be terminated when the initiator disconnects the call, even if the other participants do not disconnect. On the other hand, the full-duplex P2C session may continue when the initiator disconnects the call, if at least two of the other participants do not disconnect. These alternatives are intended to be selectable by the network 100 operator and/or the user.

The system is designed to support the following features to accommodate user and network operator preferences:
In an established P2C session, the initiator and other participants can choose to remain silent by selecting a “mute” option on their handset 120, which will cause the handset 120 microphone to be muted. The “unmute” option will allow the initiator and other participants to speak by unmuting the handset 120 microphone.
The initiator can add or drop participants during an active P2C session.
At any time during a full-duplex P2C session, the initiator can downgrade to a half-duplex P2T session.
The P2C session may be charged in different ways. For example, all charges related to the full-duplex P2C session could be charged to the initiator. On the other hand, the initiator and other participants in the full-duplex P2C session could all be charged for their own usage during the P2C session. These alternatives are selectable by the network 100 operator and/or the user.
If the network 100 operator subscribes to the “Calling Party Pays” regime, where all charges related to a P2T session or a P2C session are charged to the calling party (initiator), then the P2C session is terminated when the initiator disconnects the call, even if the other participants do not disconnect.
If the network 100 operator subscribes to the “Called Party Pays” regime, where the initiator and other participants in a P2C call are each charged for their own usage, the P2C session continues, even if the initiator disconnects, so long as there are at least two participants on the P2C session.

Generally, the facilities for the full-duplex P2C session or for upgrading the established half-duplex P2T session to the full-duplex P2C session are available to users who have subscribed to this service. The user also must possess a handset 120 with suitable modifications to allow menu interactions to service the P2C feature.

P2C Call Flows

The following sections describes the call flows for some of the major operations in the P2C service.

User Initiates a P2C Session

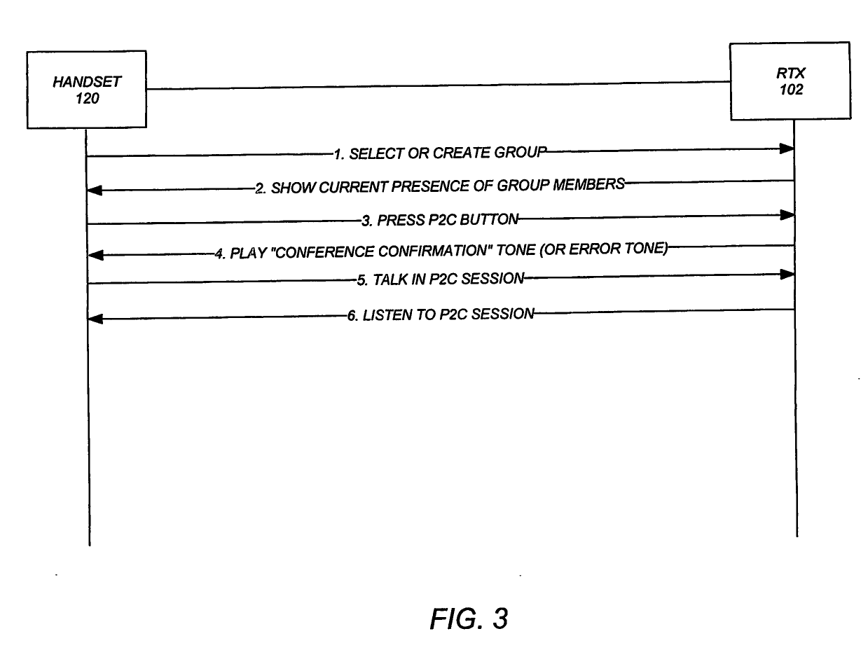

FIG. 3 is a diagram that illustrates the call flow for the user initiating a P2C session according to the preferred embodiment of the present invention.

1. The user selects or creates a group on the handset 120.

2. The RTX 102 returns one or more messages that show the current presence or availability for all group members, for all available networks. In a preferred embodiment, the current presence or availability of all group members is visually displayed on the handset 120 within a few seconds of any state change, for all available networks. (An alert tone may also be used, as specified by the user.)

3. The user presses the P2C button on the handset 120, and a corresponding message is transmitted to the RTX 102.

4. The RTX returns one or more messages containing a “Conference Confirmation” tone, if the initiator's request to initiate the P2C session is accepted by the RTX 102, or an error tone, if the initiator's request to initiate the P2C session is denied by the RTX 102.

5. During the P2C session, the user speaks into the handset 120 to talk, and a corresponding voice signal is transmitted to the RTX 102, for mixing with other audio and re-distribution to the other participants.

6. During the P2C session, the user receives messages from the RTX 102 at the handset 120, wherein the messages include the mixed audio from the participants distributed by the RTX 102.

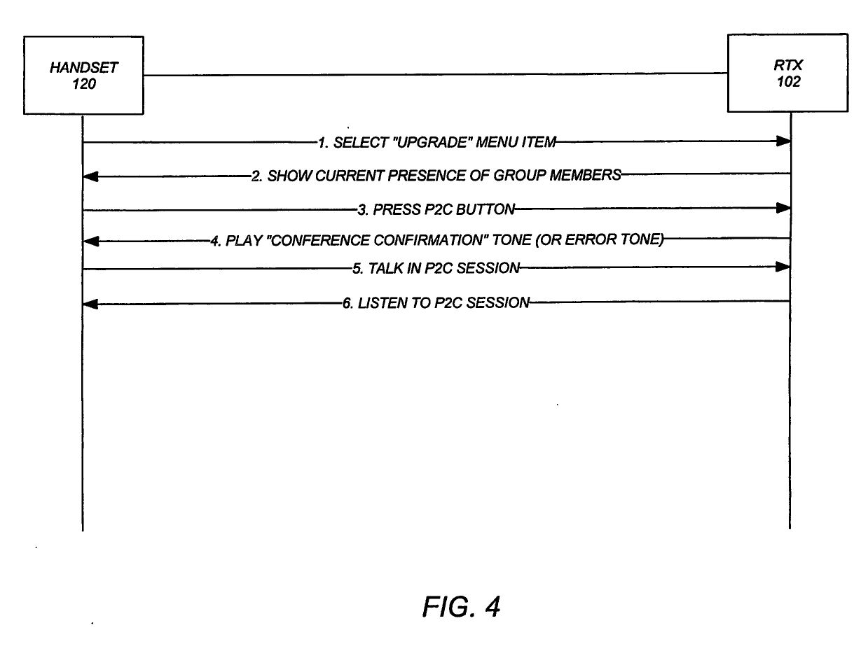

Further call processing is described in FIG. 4.

User Upgrades a P2T Session to a P2C Session

FIG. 4 is a diagram that illustrates the call flow for the user upgrading a P2T session to a P2C session according to the preferred embodiment of the present invention.

1. The user, who has already established a P2T session, presses the ‘Upgrade to P2C’ button or menu item on the handset 120, and a corresponding message is transmitted to the RTX 102.

2. The RTX returns one or more messages containing a “Conference Confirmation” tone, if the user's request to upgrade to a P2C session is accepted by the RTX 102, or an error tone, if the user's request to upgrade to a P2C session is denied by the RTX 102.

3. During the P2C session, the user speaks into the handset 120 to talk, and a corresponding message is transmitted to the RTX 102, for mixing with other audio and re-distribution to the other participants.

4. During the P2C session, the user receives messages from the RTX 102 at the handset 120, wherein the messages include the mixed audio from the participants distributed by the RTX 102.

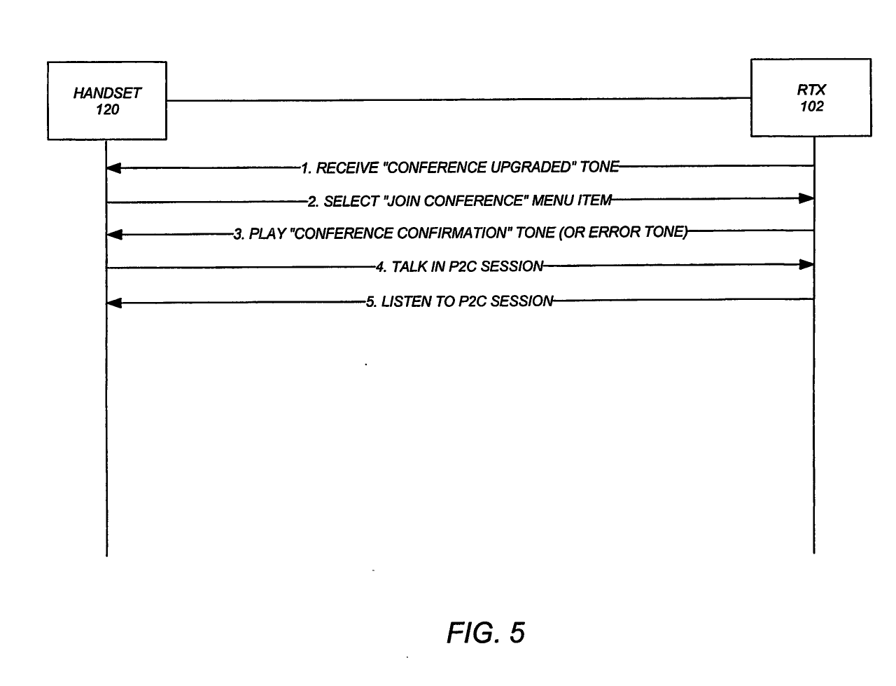

Further call processing is described in FIG. 5.

User Receives an Upgrade of a P2T Session to a P2C Session

FIG. 5 is a diagram that illustrates the call flow for the user receiving an upgrade of a P2T session to a P2C session according to the preferred embodiment of the present invention.

1. During a P2T session, the RTX sends a message containing a “Conference Upgraded” tone to the handset 120.

2. The user selects a “Join Conference” menu item on the handset 120.

3. The RTX returns one or more messages containing a “Conference Confirmation” tone, if the user's request to join the P2C session is accepted by the RTX 102, or an error tone, if the user's request to join the P2C session is denied by the RTX 102.

4. During the P2C session, the user speaks into the handset 120 to talk, and a corresponding message is transmitted to the RTX 102, for mixing with other audio and re-distribution to the other participants.

5. During the P2C session, the user receives messages from the RTX 102 at the handset 120, wherein the messages include the mixed audio from the participants distributed by the RTX 102.

Push-to-Message (P2M)

This section describes the Press-to-Message (P2M) service using the MMS (multi Media Services) protocol as the transport medium. The P2M service delivers multimedia messages (e.g., audio, video, images, data, etc.), known hereafter as P2M messages from an originator to one or more recipients.

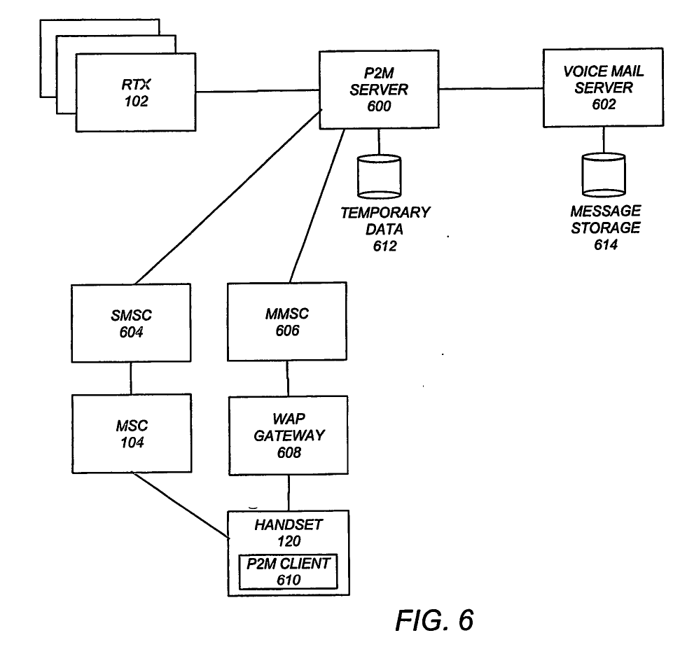

FIG. 6 illustrates a system architecture for the P2M service according to the preferred embodiment of the present invention. The system architecture includes one or more RTXs 102 coupled to a P2M server 600, which is (optionally) coupled to a Voice Mail Server 602, wherein the RTX 102 and the P2M server 600 work together to deliver P2M messages in a non-real time manner from an originator to one or more recipients, without establishing voice paths between the originator and recipients. Recipients may comprise one or more contacts, one or more groups of contacts, or a subset of a group of contacts.

The P2M Server 600 provides a message storage facility for a user's P2M messages, and may interface to the Voice Mail Server 602 to provide a message storage facility for the multimedia messages, so that a user's message storage capacity is not limited to the capacity of their handset 120. The user can store P2M messages in the P2M Server 600, retrieve P2M messages from the P2M Server 600, and reply to the messages, or forward the messages to other P2M subscribers. The P2M service supports the sending of P2M messages to one or more contacts, one or more groups of contacts, or a subset of a group of contacts.

It is also possible to integrate any existing Voice Mail Server (VMS) with the P2M service. In such situations, the VMS can notify the P2M server 600 if any new messages are waiting for a subscriber.

MMS is used as the transport mechanism for communicating the P2M messages between the handset 120 and P2M Server 600. The P2M Server 600 interfaces to an SMSC (Short Message Service Center) 604, which conveys SMS messages to the MSC 104 and then to the handset 120, as well as the reverse. In some instances, it is also possible to use MMS or IP in place of SMS messaging. In addition, the P2M Server 600 interfaces to an MMSC (MMS Service Center) 606, which conveys MMS messages to a WAP (Wireless Application Protocol) Gateway 608 and then to the handset 120, as well as the reverse. These messages received by the handset 120 are processed by a P2M Client 610 executed by the handset 120, which provides the necessary functionality for the P2M service.

The major advantages of the P2M service include the following:
Users can transmit P2M messages in a non-real-time manner without needing to establish end-to-end voice paths to the recipients.
Users can deliver P2M messages to a large number of recipients.
Users can schedule the delivery of P2M messages for a specific time.
The P2M Server 600 allows for the storage and retrieval of large P2M messages, thereby overcoming potential limitations in handset 120 message storage capacity.
The P2M service does not require any changes to the wireless network elements.
Users can request a consolidated delivery receipt for any messages sent.

A P2M subscriber wishing to send a P2M message selects a recipient (i.e., one or more contacts, one or more groups of contacts, or a subset of a group of contacts), and records the P2M message. The P2M Client 610 in the handset 120 stores the recorded P2M message into a file in a predefined format. When the user finishes recording the P2M message, the P2M Client 210 forms an MMS message with the recipient's information (such as Group Id, Member Index, etc.), attaches the file to the MMS message, and sends the MMS message to the P2M Server 600.

The P2M Server 600 receives the MMS message from the MMSC 606 over the MM7 interface. The P2M Server 600 performs authentication, extracts the recipient's information from the MMS message, and stores the P2M message in its temporary data 612. The P2M Server 600 then performs a remote query to one or more RTXs 102 to obtain the recipient's status and group member information.

The P2M server forms a new MMS message that contains the P2M message and sends it to recipients who are on line, and also stores the message in the inbox. For recipients who are off-line, the messages would be stored in the P2M server 600 and marked as new (unread) message.

The P2M Client 610 executed by the handset 120 registers with P2M Server 600 when the handset 120 is powered on, at which time the new MMS messages are delivered to the handset 120. The P2M Client 610 receives a notification from the MMSC 606 of the new MMS message, and then retrieves the new MMS message from the MMSC 606. Thereafter, the P2M Client 610 provides an alert notification to the user of the new MMS message. The P2M Client 610 also adds the new MMS message to the inbox of the handset 120, and also keeps track of read and unread messages.

Using the new MMS message, the P2M Client 610 can request delivery of the P2M message stored by the P2M Server 600. Upon receipt of the P2M message, the P2M Client 610 plays or displays any audio, video, images, data or text found in the P2M message. The P2M message may also be stored on the P2M Client 610 (even if temporarily).

The P2M Client 610 provide the necessary functionality to manage the P2M messages, regardless of where they are stored. For example, the P2M Client 610 may store a user selectable number of P2M messages in the handset 120 itself, and may store another user selectable number of P2M messages in the P2M Server 600. Further, the user can choose to retrieve, delete, forward or reply to any of the P2M messages.

Message Storage

This section explains three specific approaches for storing P2M messages.

In a first approach, the P2M Server 600 would store the P2M message as temporary data 612.

In a second approach, the P2M Server 600 would store the P2M message using the message storage 614 of the Voice Mail Server 602, wherein standard FTP (File Transfer Protocol) commands would be used to store and retrieve P2M messages from the Voice Mail Server 602. In this approach, the P2M Server 600 would store each P2M message using a Subscriber Id and Sequence Id.

In a third approach, the P2M Server 600 does not define how the P2M message should be stored in the Voice Mail Server 602. Instead, it uses a messaging interface with the Voice Mail Server 602, based on the Subscriber Id and Sequence Id. The protocol is similar to the FTP commands described above, but the protocol does not define where the P2M messages should be stored. The request and response messages would be the same as the FTP protocol described above.

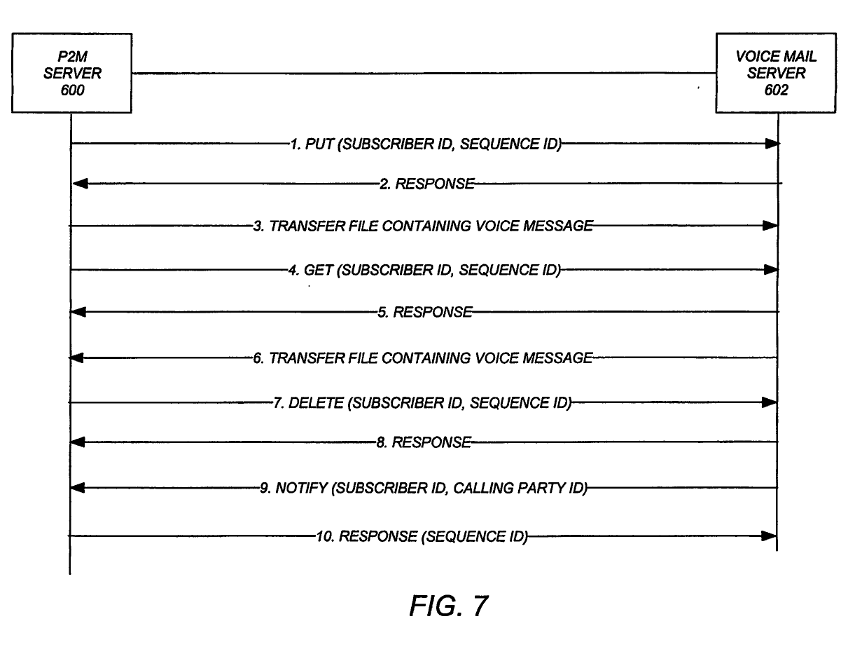

FIG. 7 is a diagram that illustrates the call flow for the third approach.

1. The P2M Server 600 sends a PUT message to the Voice Mail Server 602, wherein the message includes a Subscriber Id and Sequence Id.

2. The Voice Mail Server 602 sends a response to the P2M Server 600, acknowledging the PUT message.

3. The P2M Server 600 transfers a file containing the P2M message to the Voice Mail Server 602, and the Voice Mail Server 602 stores the file using the Subscriber Id and Sequence Id.

4. The P2M Server 600 sends a GET message to the Voice Mail Server 602, wherein the message includes a Subscriber Id and Sequence Id.

5. The Voice Mail Server 602 sends a response to the P2M Server 600, acknowledging the GET message.

6. The Voice Mail Server 602 retrieves a file containing the P2M message using the Subscriber Id and Sequence Id, and then transfers the file to the P2M Server 600.

7. The P2M Server 600 sends a DELETE message to the Voice Mail Server 602, wherein the message includes a Subscriber Id and Sequence Id.

8. The Voice Mail Server 602 deletes a file containing the P2M message using the Subscriber Id and Sequence Id, and then sends a response to the P2M Server 600, acknowledging the DELETE message.

9. The Voice Mail Server 602 sends a NOTIFY message to the P2M Server 600 indicating the Subscriber Id and Calling Party Id.

10. The P2M Server 600 responds to the Voice Mail Server 602 with a RESPONSE message with Sequence Id.

P2M Call Flows

The following sections describes the call flows for some of the major operations in the P2M service.

P2M Client Sending A P2M Message Using MMS

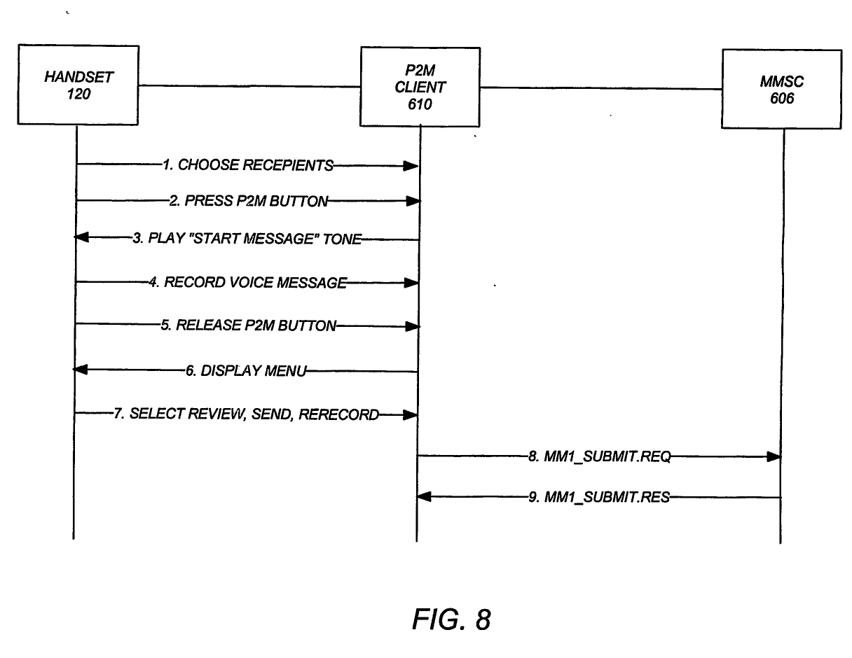

FIG. 8 is a diagram that illustrates the call flow for the P2M Client 610 sending a message using MMS according to the preferred embodiment of the present invention.

1. The user selects a recipient on the handset 120.

2. The user presses the P2M button on the handset 120.

3. The P2M Client 610 plays a Start Message tone on the handset 120.

4. The P2M Client 610 records the P2M message.

5. The user releases the P2M button on the handset 120.

6. The P2M Client 610 displays a menu on the handset 120, that indicates three options for the user: review, send or re-record.

7. The user selects either review, send or re-record from the menu on the handset 120. If review is selected, then the P2M message is played and control transfers to #6 above. If re-record is selected, then control transfers to #3 above. If send is selected, then control transfers to #8 below.

8. The P2M Client 610 forms an MMS message (MM1_SUBMIT.REQ) with the recipient's information as the text part and the file containing the P2M message as an attachment. The P2M Client 610 then sends the MMS message to the MMSC 606.

9. The MMSC 606 sends a response (MM1_SUBMIT.RES) message to the P2M Client 610.

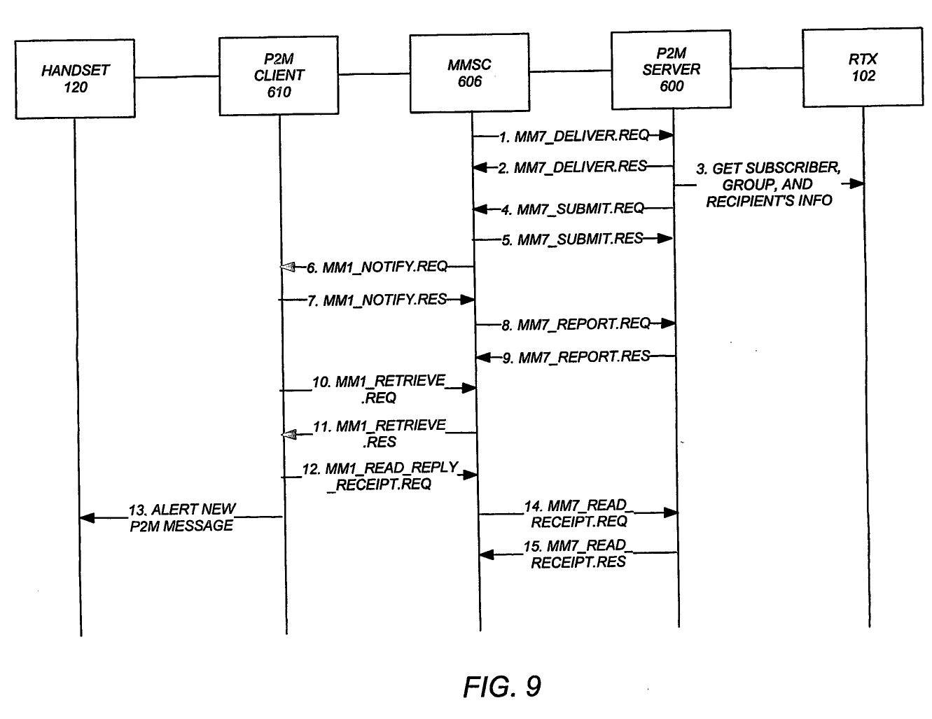

Further message processing is described in FIG. 9.

P2M Server Processing of the P2M Message

FIG. 9 is a diagram that illustrates the call flow for the P2M Server 600 processing the message according to the preferred embodiment of the present invention.

1. The MMSC 606 sends a delivery request (MM7_DELIVER.REQ) message to the P2M Server 600.

2. The P2M Server 600 sends a response (MM7_DELIVER.RES) message to the MMSC 606.

3. The P2M Server 600 sends a query message to the RTX 102 to obtain subscriber, group and recipient information. At this point, the P2M Server 600 assigns a unique Message Id to the P2M message, for later reference. A new MMS message is formed and then sent to any recipients that are currently online. The new MMS message may be locally stored and sent later to recipients that are currently offline, when they are online again.

4. The P2M Server 600 sends a submit request (MM7_SUBMIT.REQ) message to the MMSC 606.

5. The MMSC 606 sends a response (MM7_SUBMIT.RES) message to the P2M Server 600.

6. The MMSC 606 sends a notify request (MM1_NOTIFY.REQ) message to the P2M Client 610. The P2M Client 610 uses the Subject field in the notify request message to identify the P2M message.

7. The P2M Client 610 sends a response (MM1_NOTIFY.RES) message to the MMSC 606.

8. The MMSC 606 sends a report request (MM7_REPORT.REQ) message to the P2M Server 600.

9. The P2M Server 600 sends a response (MM7_REPORT.RES) message to the MMSC 606.

10. The P2M Client 610 sends a retrieve request (MM1_RETRIEVE.REQ) message to the MMSC 606. The P2M Client 610 retrieves the MMS message immediately, and preferably, in the background.

11. The MMSC 606 sends a response (MM1_RETRIEVE.RES) message to the P2M Client 610.

12. Upon completion of the download of the MMS message, the P2M Client 610 sends a read reply receipt request (MM1_READ_REPLY_RECEIPT.REQ) message to the MMSC 606.

13. In addition, once the download is completed, the P2M Client 610 plays an Alert New P2M Message tone is played and/or an indication is displayed on the handset 120. The user can choose to display or play the P2M message immediately or at a later time.

14. The MMSC 606 sends a read reply receipt request (MM7_READ_RECEIPT.REQ) message to the P2M Server 600.

15. The P2M Server 600 sends a response (MM7_READ_RECEIPT.RES) message to the MMSC 606.

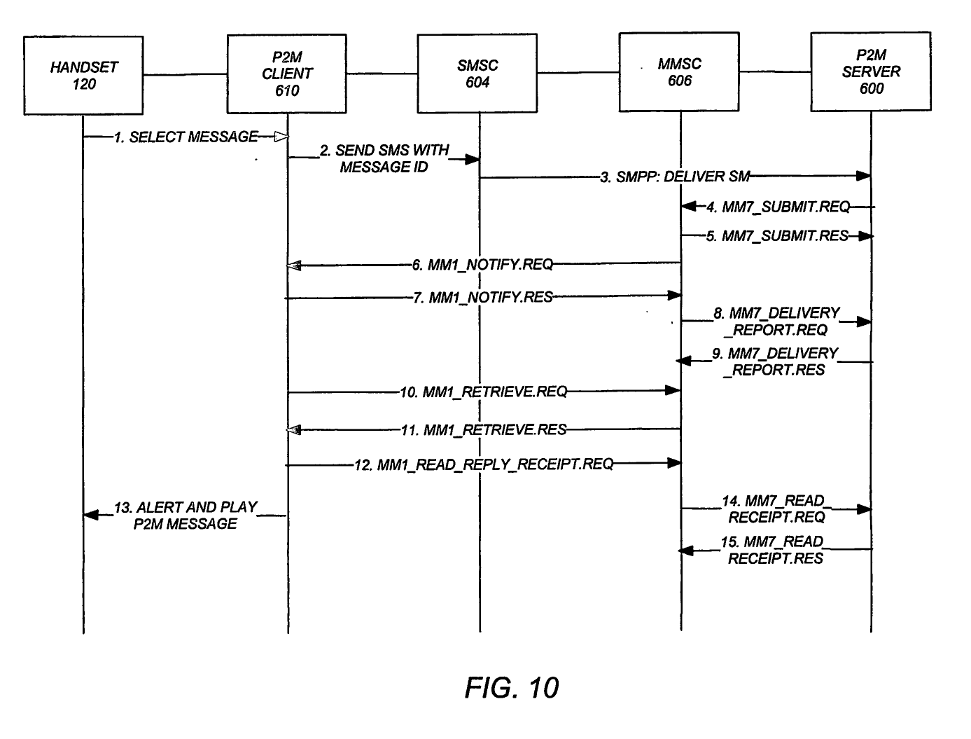

Further message processing is described in FIG. 10.

P2M Client Retrieving the P2M Message

FIG. 10 is a diagram that illustrates the call flow for the P2M Server 600 processing the message according to the preferred embodiment of the present invention.

1. The user selects a message for retrieval on the handset 120.

2. To retrieve a P2M message, the P2M Client 610 sends an SMS message containing the details of the P2M message to be retrieved, i.e., the corresponding Message Id, to the SMSC 604.

3. The SMSC 604 sends a deliver (SMMP: DELIVER SM) message with the corresponding Message Id to the P2M Server 600 via the MMSC 606. Upon receipt of the message, the P2M Server 600 retrieves the P2M message using the Message Id.

4. The P2M Server 600 sends a submit request (MM7_SUBMIT.REQ) message to the MMSC 606.

5. The MMSC 606 sends a response (MM7_SUBMIT.RES) message to the P2M Server 600.

6. The MMSC 606 sends a notify request (MM1_NOTIFY.REQ) message to the P2M Client 610 via the SMSC 604.

7. The P2M Client 610 sends a response (MM1_NOTIFY.RES) message to the MMSC 606 via the SMSC 604.

8. The MMSC 606 sends a delivery report request (M7_DELIVERY_REPORT.REQ) message to the P2M Server 600.

9. The P2M Server 600 sends a response (MM7_DELIVERY_REPORT.RES) message to the MMSC 606.

10. The P2M Client 610 sends a retrieve request (MM1_RETRIEVE.REQ) message to the MMSC 606 via the SMSC 604.

11. The MMSC 606 sends a response (MM1_RETRIEVE.RES) message to the P2M Client 610 via the SMSC 604.

12. The P2M Client 610 sends a read reply receipt request (MM1_READ_REPLY_RECEIPT.REQ) message to the MMSC 606 via the SMSC 604.

13. The P2M Client 610 plays an Alert tone (or displays text) and then displays or plays the P2M message on the handset 120.

14. The MMSC 606 sends a read receipt request (MM7_READ_RECEIPT.REQ) message to the P2M Server 600.

15. The P2M Server 600 sends a response (MM7_READ_RECEIPT.RES) message to the MMSC 606.

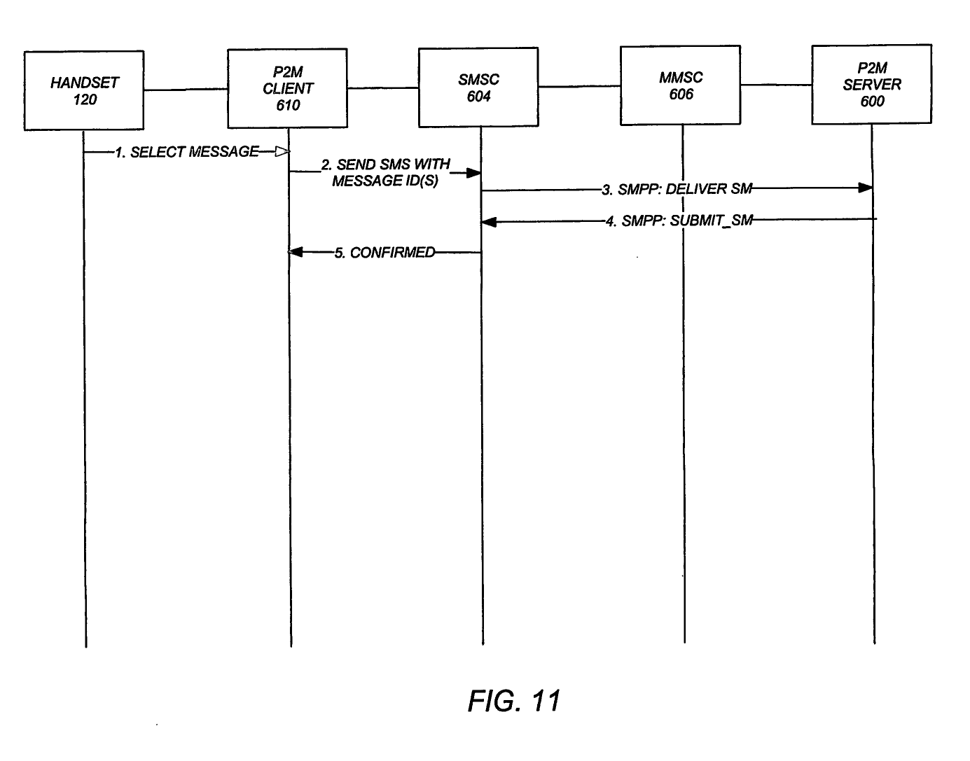

Further message processing is described in FIG. 11.

P2M Client Deleting the P2M Message

FIG. 11 is a diagram that illustrates the call flow for the P2M Client 610 deleting the P2M message according to the preferred embodiment of the present invention.

1. The user selects a P2M message for deletion on the handset 120.

2. To delete a P2M message, the P2M Client 610 sends an SMS message containing the details of the P2M message to be deleted, i.e., the corresponding Message Id, to the SMSC 604. The P2M message is also deleted locally on the handset 120 (if it exists).

3. The SMSC 604 sends a deliver (SMMP: DELIVER SM) message with the corresponding Message Id to the P2M Server 600 via the MMSC 606. Upon receipt of the message, the P2M Server 600 deletes the P2M message using the Message Id.

4. The P2M Server 600 sends a submit (MM7_SUBMIT SM) message as a response to the SMSC 604 via the MMSC 606.

5. The SMSC 604 sends a confirmation message to the P2M Client 610.

Message Inbox Functionality

The P2M Message Inbox functionality is provided to support management of messages as in email. The P2M Client 610 provides functionality to list out previously received P2M messages for a specified duration (configured in the P2M Server 600 for the subscriber). The P2M Client 610 can store a specified number of P2M messages in the handset 120 and the remaining messages would be stored in the P2M Server 600. The user can play, delete, forward or reply to any of the saved messages. Further, the P2M Client 610 can download, via MMS, P2M messages stored in the P2M Server 600 through an SMS request to the P2M Server 600 indicating the Message D (Identification) of the selected message.

Fragmentation and Reassembly of Long Messages

The size of P2M messages conveyed over MMS is limited in size to around 30 Kilobytes, which for voice messages indicates a limit of 40 seconds. Using fragmentation and reassembly, longer duration messages can be accommodated. For longer duration messages, the P2M Client 610 divides the message into multiple smaller messages to fit within the constraint of MMS. The P2M Server 600 receives and sends the fragmented MSS messages to the intended recipients. The terminating P2M Client 610 would reassemble the fragmented messages and regenerate the original long duration message.

Zero Delay Call Setup

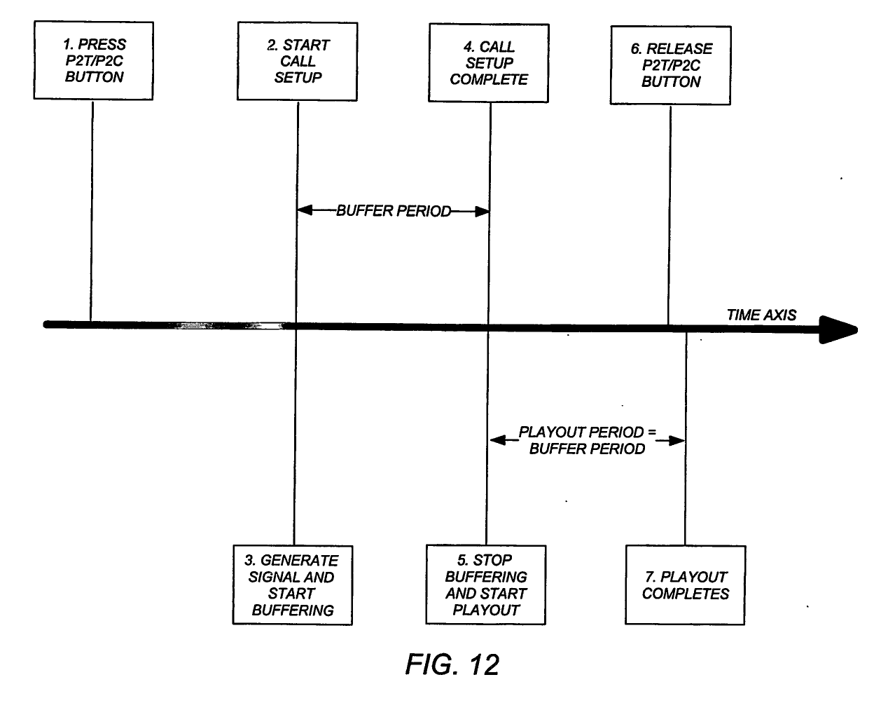

FIG. 12 depicts the processing at a handset 120 that interfaces to the wireless network to provide voice services between a user and one or more destinations, wherein call setup for the voice services involves zero delay. Specifically, the user starts talking immediately upon initiation of the call setup, the user's speech is buffered by the handset 120, and the buffered speech is forwarded to the destination upon completion of the call setup.

The steps involved are indicated below:
1. The user initiates a P2T /P2C session by pressing the P2T /P2C button on the handset 120 (or by performing an equivalent operation such as choosing a menu item in the handset 120).
2. Call setup starts.
3. The handset 120 generates a confirmation signal, the user starts talking immediately upon receiving the confirmation signal, and the handset 120 buffers the user's speech for a specified duration. The confirmation signal may comprise a “chirp,” “click,” “pop-up message,” etc. Alternatively, the handset 120 may receive an error signal if one or more of the destinations is unavailable, or if the user if the user does not control a floor for group services. The use of such signals is optional, not mandatory, and thus the signals can be employed according to a user preference.
4. Call setup completes.
5. When the specified duration expires, the handset 120 stops buffering the user's speech and starts its playout of the buffered speech for transmission to the destination. The specified duration may be determined by a user preference, and generally comprises the smaller of a time period required to complete the call setup or a time period between the user pressing and releasing a button on the handset 120.
6. Finally, the user releases the P2T /P2C button on the handset 120. The above steps apply to the first push of the button only.
7. Playout of the buffered speech completes.

Although the steps of FIG. 12 illustrate the situation where the specified duration is equal to the call setup time, those skilled in the art will recognize that the specified duration may be less than the call setup time, for example, when the P2T /P2C button is released by the user before call setup completes.

Note also that the user may talk for an arbitrary amount of time, but the buffer period is limited and, as indicated above, is the smaller of call setup time or the period of the first push of the P2T /P2C button.

As an example, assume that the call setup takes 2 seconds, but the first push of the P2T /P2C button may be 4 seconds long. In that case, only 2 seconds of speech are buffered and playout of those 2 seconds of speech occurs as soon as call setup is completed. On the other hand, if the first push of the P2T /P2C button is only 1.5 seconds, only 1.5 seconds of speech is buffered, and playout of those 1.5 seconds of speech occurs after call setup is completed. In any case, the playout of the buffered speech starts only after call setup is complete.

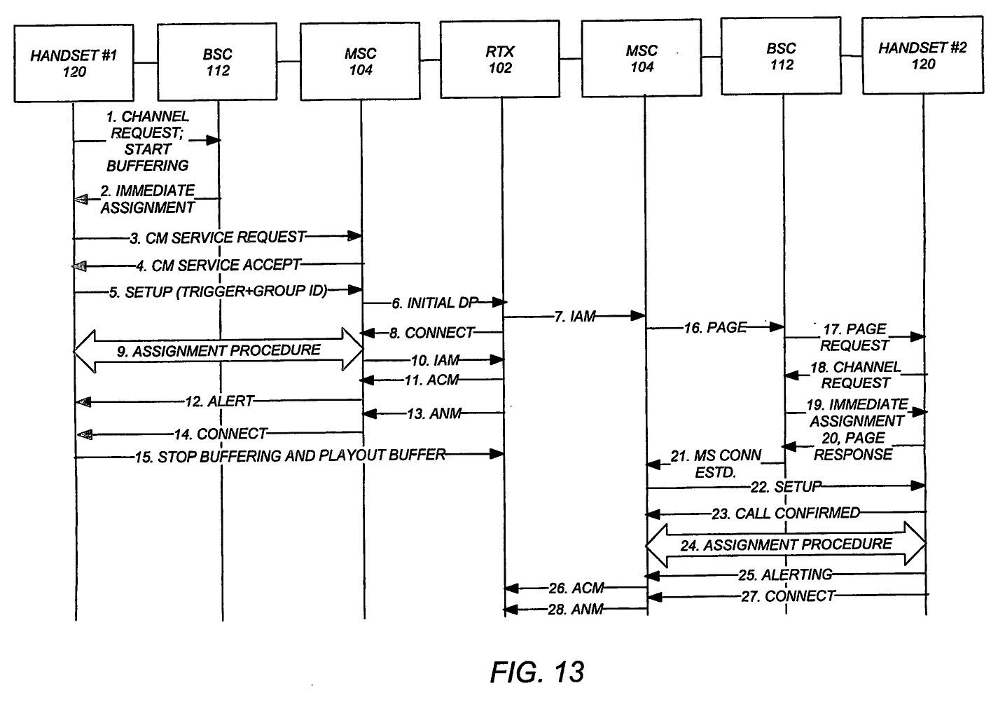

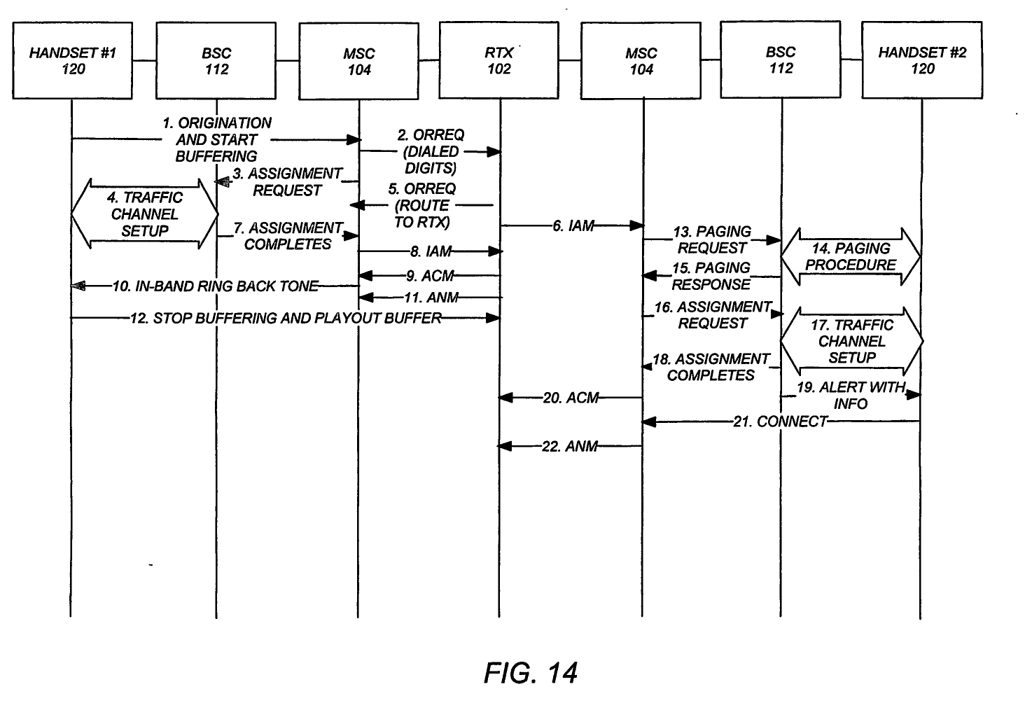

FIGS. 13 and 14 illustrate the call flows for initial call establishment for GSM and CDMA P2T or P2C services, respectively, incorporating the zero delay call set-up. This solution is equally applicable to other wireless systems such as TDMA and evolutions of existing 2 G solutions such as 2.5 G systems, 3G systems, etc.

FIG. 13 is a diagram that illustrates the call flow for a GSM P2T or P2C call according to a preferred embodiment of the present invention.
1. The first or originating handset 120 (identified in the figure as handset #1) requests an assignment of a dedicated signaling channel for call origination, and starts buffering the user's speech.
2. A dedicated signaling channel is assigned and intimated to the first handset 120.
3. A CM Service Request is send to the MSC 104 to initiate a call setup procedure. Upon receiving the CM Service Request, the MSC 104 may delay the authentication in order to speed up the call setup.
4. The MSC 104 sends a CM Service Accept to the first handset 120 in order to proceed with call setup. In this case, authentication may be initiated by the MSC 104 at a later time.
5. The first handset 120 sends a setup message with the dialed digits. The dialed digits contain the access code for the group call and the group ID.
6. Because the origination trigger criteria is met as per the subscriber's profile for P2T /P2C service, the MSC 104 originates an Initial DP (Detection Point) Request to the RTX 102 for further service interaction.
7. After receiving the Initial DP Request from the MSC 104, the RTX 102 looks into its database of group information in order to obtain directory numbers of group members belonging to the group ID specified in the message. For each member of the group, the RTX 102 originates an IAM and sends it to the MSC 104 with a directory number as the called party number. The RTX 102 also sends CIC information for each terminating leg to the MSC 104.
8. The GSM SCF (Service Control Function) instructs the MSC 104 to connect to the RTX 102 by specifying a redirection number.
9. The MSC 104 triggers the assignment procedure for allocating terrestrial resources between the BSC 112 and MSC 104, and radio resources for the first handset 120. The first handset 120 is notified about the allocated channel for this call.
10. The MSC 104 begins routing the call based on the redirection number received from the GSM SCF. The MSC 104 terminates the call to the RTX 102 by sending an IAM.
11. The RTX 102, after receiving the IAM, immediately responds to the MSC 104 with an ACM, and subsequently, an ANM with no delay between them.
12. The MSC 104 sends an Alert to the first handset 120 to trigger alerting at the first handset 120.
13. The RTX 102 sends an ANM to the MSC 104.
14. The MSC 104 sends a connect to the first handset 120, which stops the alerting tone at the first handset 120.
15. The first handset 120 stops buffering the user's speech, and begins the playout of the buffered speech, in order to transmit the speech packets to the RTX 102.
16. The MSC 104 send a paging request to the BSC 112 to locate the second or terminating handset 120 (identified in the figure as handset #2).
17. The BSC 112 performs a paging procedure to locate the second handset 120.
18. The second handset 120 requests a dedicated signaling channel.
19. A dedicated signaling channel is assigned and intimated to the second handset 120.
20. The second handset 120 sends a paging response through the dedicated signaling channel.
21. When the BSC 112 receives the paging response from the second handset 120, it sends an MS Conn Estd (Mobile Station Connection Established) message to the MSC 104.
22. The MSC 104 sends a Setup message to the second handset 120 with information such as the called party number and group ID.
23. The second handset 120 responds with a Call Confirmed message to the MSC 104.
24. The MSC 104 performs an assignment procedure to allocate terrestrial and radio resources.
25. After successful allocation of all resources, the second handset 120 sends an Alerting message to the MSC 104 to indicate that it is alerting.
26. The MSC 104 sends an ACM to the RTX 102 confirming the alerting of the terminating handset 120.
27. The second handset 120 (without waiting for user response) sends a Connect message to the MSC 104 if the service does not require the user to press any key on the handset 120 to accept the call. This provides instant connectivity between the originating and terminating handsets 120.
28. The MSC 104 sends an ANM message to the RTX 102 and the RTX 102 completes the one-way voice path from the originating handset 120 to terminating handset 120.

FIG. 14 is a diagram that illustrates the call flow for a CDMA P2T call according to a preferred embodiment of the present invention.
1. The first or originating handset 120 (identified in the figure as handset #1) originates a group call, and starts buffering the user's speech.
2. Upon receiving the origination request, the MSC 104 analyzes the dialed digits and determines that the trigger code in the called party IE meets the origination trigger criteria. On satisfying the origination trigger criteria, an ORREQ (Origination Request) message is sent to the RTX 102. The ORREQ contains the dialed digits.
3. The MSC 104 begins allocating terrestrial resources required for the call between the BSC 112 and the MSC 104, and sends CIC (Circuit Identity Code) information in an Assignment request to the BSC 112.
4. The BSC 112 performs a traffic channel setup for the first handset 120, which initiates the radio channel allocation procedure.
5. Meanwhile, the RTX 102 analyzes the dialed digits and identifies the group id. It responds to the MSC 104 with an ORREQ message, which contains the routing number to the RTX 102 so that the MSC 104 can terminate this group call to the RTX 102.

6. The RTX 102 gets the group id from the dialed digits received in the ORREQ message. It obtains member information including a Mobile Directory Number (MDN) from the group database and begins setting up terminating legs. Based on the MDN, it sends an LAM (initial Address Message) message to the MSC 104. The terminating legs are set-up in parallel with originating leg set-up to speed up the call set-up time.
7. Subsequent to the first handset 120 acquiring the traffic channel, the BSC 112 sends an Assignment Complete message to the MSC 104.
8. The MSC 104 begins to route the call based on routing info (TERMLIST) received from the RTX 102 in the ORREQ message. The MSC 104 sends an LAM message to the RTX 102.
9. The RTX 102 after receiving the LAM, immediately responds to the MSC 104 with an ACM (Address Complete Message), and subsequently ANM (Answer Message) with no delay between them.
10. The MSC 104 plays an in-band ring back tone after receiving the ACM.
11. The ANM is received by the MSC 104 and it stops the ring back tone.
12. The first handset 120 stops buffering the user's speech, and begins the playout of the buffered speech, in order to transmit the speech packets to the RTX 102.
13. The MSC 104 sends a paging request to the BSC 112 in order to locate the second or terminating handset 120 (identified in the figure as handset #2).
14. The BSC 112 performs a paging procedure for the second handset 120.
15. Once a paging response is obtained from the second handset 120, the BSC 112 gives a paging response to the MSC 104.
16. The MSC 104 allocates a terrestrial circuit between the MSC 104 and BSC 112, and sends the information to the BSC 112 in an Assignment Request. The Assignment Request message also contains the calling party number with its group ID and signal IE for the alerting second handset 120.
17. The BSC 112 performs a traffic channel setup procedure for the second handset 120, which initiates the radio channel allocation procedure.
18. Subsequent to completion of the traffic channel setup, the BSC 112 sends an Assignment Complete message to the MSC 104.
19. The BSC 112 sends an Alert With Info message to the second handset 120 to start alerting. This message has the calling party number, which contains the group ID. The second handset 120 understands from this group ID that the call is a P2T or P2C, and ignores signal IE in this message.
20. The MSC 104 sends an ACM to the RTX 102 after receiving an Assignment Complete message from the BSC 112, indicating that the second handset 120 is alerting.
21. The second handset 120 (without waiting for user response) sends a connect message to the BSC 112 and MSC 104 if the service does not require the user to press any key on the handset 120 to accept the call. This provides instant connectivity between the originating and terminating handsets 120.
22. The MSC 104 sends an ANM message to the RTX 102 and the RTX 102 completes the one-way voice path from the originating handset 120 to the terminating handset 120.

Conclusion

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. An apparatus for providing group voice services in a wireless network, comprising:
a real-time exchange that interfaces to the wireless network to provide a fall-duplex Push-to-Conference (P2C ) session between an initiator and two or more other participants, wherein the P2C session comprises a fall-duplex conference call, and both the real-time exchange and handsets participating in the P2C session communicate with each other using call setup and in-band signaling within the wireless network.

2. The apparatus of claim 1, wherein the participants comprise one or more contacts, one or more groups of contacts, or a subset of a group of contacts.

3. The apparatus of claim 1, wherein the initiator initiates the full-duplex P2C session by invoking “Push-to-Conference” on their handset.

4. The apparatus of claim 1, wherein the initiator upgrades an established half-duplex Push-to-Talk (P2T ) session to the full-duplex P2C session by invoking “Upgrade to Conference” on their handset.

5. The apparatus of claim 1, wherein the initiator's handset signals the real-time exchange via the wireless network, and the real-time exchange initiates and manages the fall-duplex P2C session.

6. The apparatus of claim 1, wherein the real-time exchange causes the wireless network to perform call setup with the other participants for the full-duplex P2C session, and the real-time exchange initiates and manages the full-duplex P2C session.

7. The apparatus of claim 1, wherein the real-time exchange causes the wireless network to signal the other participants to join the full-duplex P2C session.

8. The apparatus of claim 1, wherein the other participants invoke “Join Conference” on their handsets to join the full-duplex P2C session.

9. The apparatus of claim 1, wherein the real-time exchange mixes audio streams from the initiator and other participants, and delivers these mixed audio streams to the initiator and other participants.

10. The apparatus of claim 1, wherein the initiator and other participants can choose to remain silent by invoking a “mute” option on their handsets, which causes the handset's microphone to be muted.

11. The apparatus of claim 1, wherein the initiator can add or drop participants during the full-duplex P2C session.

12. The apparatus of claim 1, wherein the initiator can downgrade the full-duplex P2C session to a half-duplex P2T session.

13. The apparatus of claim 1, wherein all charges related to the full-duplex P2C session are charged to the initiator.

14. The apparatus of claim 1, wherein the fill-duplex P2C session is terminated when the initiator disconnects the call, even if the other participants do not disconnect.

15. The apparatus of claim 1, wherein the initiator and other participants in the full-duplex P2C session are all charged for usage.

16. The apparatus of claim 1, wherein the full-duplex P2C session continues when the initiator disconnects the call, if at least two of the other participants do not disconnect.

17. An apparatus for providing group voice services in a wireless network, comprising:
a real-time exchange coupled to a Push-to-Message (P2M ) server, wherein the real-time exchange interfaces to the wireless network, and the real-time exchange and the P2M server work together to deliver multimedia messages in a non-real time manner from an originator to one or more recipients, without establishing voice paths between the originator and recipients.

18. The apparatus of claim 17, wherein the P2M server provides a message storage facility for the multimedia messages.

19. The apparatus of claim 18, wherein the P2M server interfaces to a voice mail server to provide a message storage facility for the multimedia messages.

20. The apparatus of claim 17, wherein the recipients comprise one or more contacts, one or more groups of contacts, or a subset of a group of contacts.

21. The apparatus of claim 17, wherein the multimedia messages are scheduled for delivery at a specific time.

22. The apparatus of claim 17, wherein the P2M server performs authentication, extracts the recipient's information from the multimedia message, and stores the multimedia message.

23. The apparatus of claim 17, wherein the P2M server performs a query to one or more real-time exchanges to obtain the recipient's status.

24. The apparatus of claim 17, wherein the P2M server forms a new message that contains information to retrieve the multimedia message.

25. The apparatus of claim 24, wherein the new message is sent to online recipients.

26. The apparatus of claim 24, wherein the new message is stored for later delivery to offline recipients.

27. The apparatus of claim 24, wherein a P2M client executed by a handset registers with the P2M server when the handset is powered on, at which time the new messages are delivered to the P2M client.

28. The apparatus of claim 27, wherein the P2M client receives a notification of the new message, and then retrieves the new message.

29. The apparatus of claim 27, wherein the P2M client provides an alert notification of the new message.

30. The apparatus of claim 27, wherein the P2M client requests delivery of the multimedia message stored by the P2M server using the new message.

31. The apparatus of claim 27, wherein the P2M client plays or displays the multimedia message upon receipt of the P2M message.

32. The apparatus of claim 27, wherein the P2M client and the P2M server provide message inbox functionality to allow for storage, play back, reply, delete or forwarding of messages.

33. The apparatus of claim 27, wherein the P2M client and the P2M server provide message fragmentation and reassembly to enable exchange of long duration multimedia messages.

34. An apparatus for providing voice services in a wireless network, comprising:
a handset that interfaces to the wireless network to provide the voice services between a user and one or more destinations, wherein call setup involves zero delay.

35. The apparatus of claim 34, wherein the user starts talking immediately upon initiation of the call setup, the user's speech is buffered by the handset, and the buffered speech is forwarded to the destination upon completion of the call setup.

36. The apparatus of claim 35, wherein the user starts talking immediately upon receiving a confirmation signal.

37. The apparatus of claim 35, wherein the handset receives an error signal if one or more of the destinations is unavailable.

38. The apparatus of claim 35, wherein the user receives an error signal if the user does not control a floor for group services.

39. The apparatus of claim 35, wherein the user's speech is buffered by the handset for a specified duration.

40. The apparatus of claim 39, wherein the specified duration is determined by a user preference.

41. The apparatus of claim 39, wherein the specified duration comprises a time period required to complete the call setup.

42. The apparatus of claim 39, wherein the specified duration comprises a time period between the user pressing and releasing a button on the handset.
